(19) United States
(12) Patent Application Publication
(10) Pub. No.: US 2021/0246522 A1
(43) Pub. Date: Aug. 12, 2021

(54) METHODS FOR CONTROLLING THE POSITION OF FURNASE LANCES

(71) Applicants: Jinchiro Nakano, Albany, OR (US); Anna Nakano, Albany, OR (US)

(72) Inventors: Jinchiro Nakano, Albany, OR (US); Anna Nakano, Albany, OR (US)

(21) Appl. No.: 17/239,489

(22) Filed: Apr. 23, 2021

Related U.S. Application Data
(63) Continuation of application No. PCT/US2019/057649, filed on Oct. 23, 2019.
(60) Provisional application No. 62/749,485, filed on Oct. 23, 2018.

(51) Int. Cl. C21C 5/46; C21C 5/32; F27B 3/22; F27D 19/00

(52) U.S. Cl. CPC C21C 5/462; C21C 5/32; C21C 5/4673; F27D 2003/164; F27D 19/00; F27D 2019/0003; F27D 2019/0021; F27B 3/225

(57) ABSTRACT

Methods for controlling the position of a lance supplying oxygen to a furnace containing a bath of molten metal. The methods include the steps of continuously detecting actual conditions associated with the furnace, continuously comparing the actual conditions to target parameters corresponding to the actual conditions, and continuously adjusting the position of the lance with respect to the furnace based on the comparison of the actual conditions to the target parameters.

### CROSS REFERENCE TO RELATED APPLICATIONS

This application claims priority to copending U.S. Application Ser. No. 62/749,485, filed on Oct. 23, 2018, and to PCT Application, No. PCT/US2019/057649, filed on Oct. 23, 2019, which is hereby incorporated by reference for all purposes.

### BACKGROUND

The present disclosure relates generally to methods for controlling the position of lances used in basic oxygen furnaces. In particular, methods for controlling the position of lances in response to detected conditions associated with the furnace are described.

Basic oxygen furnace (BOF) processes are commonly utilized in the steelmaking industry to convert pig iron into steel. At a high level, a BOF process involves introducing oxygen with a lance into a furnace containing molten iron. The furnace is also known as a converter. The oxygen introduced by the lance facilitates chemical reactions to produce steel with desired qualities, including oxidizing the carbon in the molten iron, forming slag, and reducing or removing unwanted chemical elements.

While well established, known methods for operating BOF processes are still not entirely satisfactory. For example, current methods of operating BOF processes struggle to optimize the substantial amounts of energy consumed during BOF processes. Further, conventional BOF methods are insufficiently dynamic and not responsive to changing conditions.

For example, conventional BOF methods do not dynamically adjust the position of the lance to reflect rapid condition changes in the furnace and to improve the performance of the BOF process. Instead, in existing traditional BOF practices, the lance is in general moved to predetermined working positions in the furnace and held for certain lengths of time depending on target properties and then moved up at the end of the practice. The working position of the lance is often predetermined based on experiments and experience, and therefore fixed for each converter (i.e., unique and specific to each converter's characteristics). In some cases, the lance may be lowered to another level (predetermined and fixed for each converter) to produce low carbon steels by losing a certain amount of iron to slag. However, conventional BOF methods do not dynamically or continuously adjust the position of the lance based on real-time conditions associated with the BOF process.

Thus, there exists a need for methods for controlling the position of BOF lances accommodating such rapid changes, which improve upon and advance the design of known BOF methods. Examples of new and useful methods relevant to the needs existing in the field are discussed below.

Examples of references relevant to BOF methods include U.S. Pat. Nos. 3,301,662, 3,350,196, 3,520,678, and 3,757,092, and Indian Patent No. 234145. The complete disclosures of the above patents and patent applications are herein incorporated by reference for all purposes.

### SUMMARY

The present disclosure is directed to methods for controlling the position of a lance supplying oxygen to a furnace containing a bath of molten metal. The methods include the steps of continuously detecting actual conditions associated with the furnace, continuously comparing the actual conditions to target parameters corresponding to the actual conditions, and continuously adjusting the position of the lance in the furnace based on the comparison of the actual conditions to the target parameters.

### BRIEF DESCRIPTION OF THE DRAWINGS

FIG. 1 is a flow diagram of steps in a first example of a method for controlling the position of a lance supplying oxygen to a furnace.

FIG. 2 is a flow diagram showing details of a detection step included in the method shown in FIG. 1.

FIG. 3 is a flow diagram showing details of a comparison step included in the method shown in FIG. 1.

FIG. 4 is a flow diagram showing details of a lance position adjustment step included in the method shown in FIG. 1.

FIG. 5 is a flow diagram showing details of a vertical movement step included in the step shown in FIG. 4,

FIG. 6 is a schematic view of a system including a furnace containing a bath of molten metal in which a lance supplies oxygen with components for detection, comparison, and adjustment steps in the method shown in FIG. 1 depicted.

### DETAILED DESCRIPTION

The disclosed methods will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various methods are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

Contextual Details

The features of items used in conjunction with the methods described herein will first be briefly described to provide context and to aid the discussion of the methods.

Basic Oxygen Furnace

The methods disclosed herein adjust the position of a lance supplying oxygen in a basic oxygen furnace to convert molten pig iron to steel with desired properties. Among many other conditions, such as oxygen flow rate, the position of the lance relative to the molten pig iron will affect the chemical reactions occurring within the furnace. The methods may be utilized with any currently known or later developed type of lance and furnace used in basic oxygen furnace processes. Further, the methods disclosed herein may be used for any currently known or later developed basic oxygen furnace-like processes, including electric arc furnaces and their combined furnaces configured to produce steel with desired properties.

Methods for Controlling Furnace Lances

With reference to the figures, methods for controlling furnace lances will now be described. The methods discussed herein function to adjust the position of a lance in a basic oxygen furnace in response to detected conditions associated with the furnace.

The reader will appreciate from the figures and description below that the presently disclosed methods address many of the shortcomings of conventional BOF methods. For example, the methods discussed herein better optimize the substantial amounts of energy consumed during BOF processes as compared to conventional BOF methods. Further, the present methods dynamically adjust in response to changing conditions. Moreover, the methods described below improve over conventional methods by dynamically and continuously adjusting the position of the lance to reflect conditions in the furnace to improve the performance of the BOF process.

### Method Embodiment One

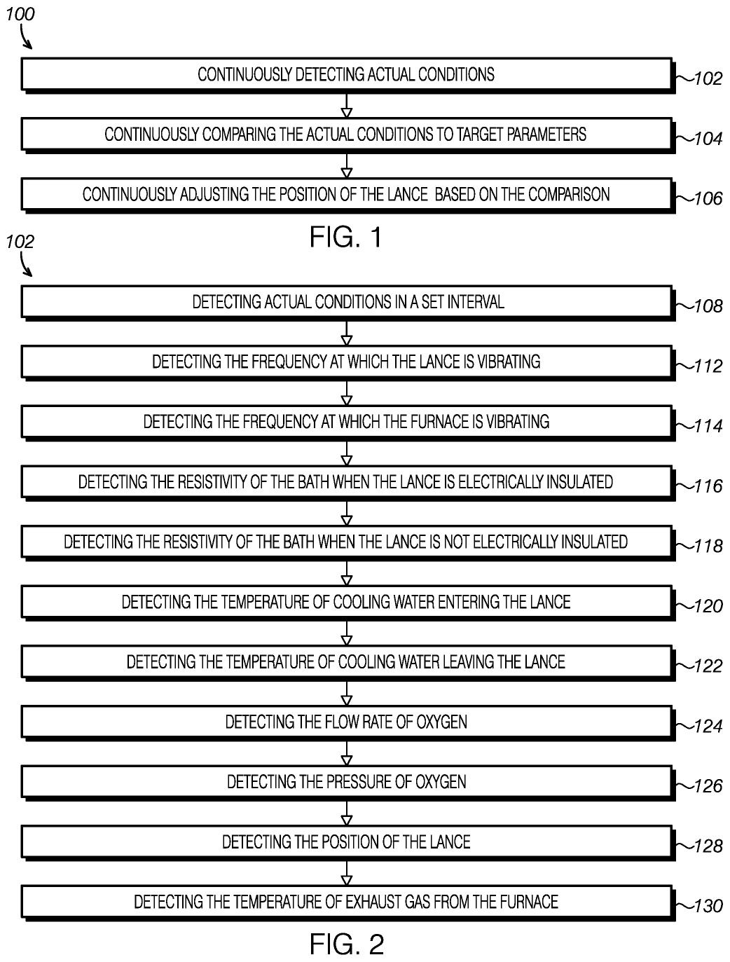

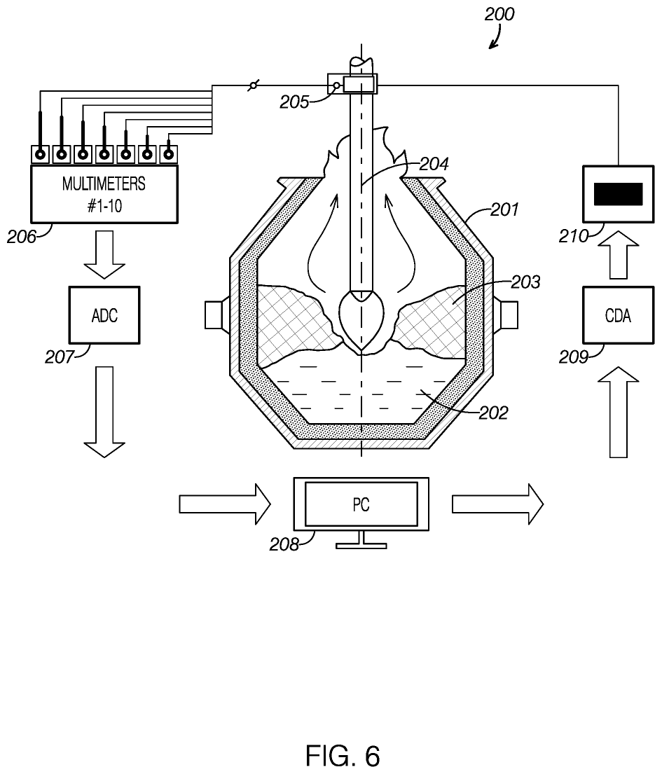

With reference to FIGS. 1-6, a first example of a method, method 100, will now be described. FIGS. 1-5 depict steps included in method 100 and FIG. 6 depicts a system 200 suitable for effectuating method 100.

As can be seen in FIG. 6, a basic oxygen furnace system 200 includes a furnace 201, a lance 204, a junction 205, measuring devices 206, an analog-to-digital converter 207, a computing device 208, a digital-to-analog converter 209, and a controller 210. The reader can see in FIG. 6 that molten metal 202 in the form of pig iron and slag 203 is contained within furnace 201. Lance 204 is positioned a selected distance above molten metal 202 and is supplying oxygen within furnace 201 to fuel exothermic reactions with molten metal 202 to convert it to steel with desired properties.

Measuring devices 206 detect actual real-time conditions associated with the basic oxygen furnace process, including conditions associated with furnace 201 and lance 204. Measuring devices 206, junction 205, analog-to-digital converter 207, computing device 208, digital-to-analog converter 209, and controller 210 cooperate to perform method 100 described below. In some examples, the system includes fewer, additional, or alternative components than depicted in FIG. 6. The measuring devices may be a set of multimeters, sensors, or any device that can detect actual conditions. Measuring device 206 may communicate with computing device 208 wirelessly or with wires.

For example, in some examples, a person manually detects one or more actual conditions without automated measuring devices and associated data communication components. Adjusting the position of the lance may be performed manually or with the aid of actuators or other mechanical devices. An automated controller device may trigger a mechanical device to move the lance or a person may directly control when the lance is moved and to what position.

A person may compare actual conditions to target parameters using computers, such as with a processor according to programmed instructions. Additionally or alternatively, a person may compare actual conditions to target parameters by consulting reference manuals, books, or guides without the aid of computers. In some examples, the target parameters are stored in computer-readable memory and, in other examples, the parameters are available on paper charts or other reference sources. In computerized examples, the programed instructions may include instructions to compare actual condition data corresponding to the actual conditions detected to the target parameters read from the computer-readable memory.

Turning attention to FIGS. 1-5, the reader can see that method 100 includes three main steps: continuously detecting actual conditions associated with the furnace at step 102, continuously comparing the actual conditions to target parameters corresponding to the actual conditions at step 104, and continuously adjusting the position of the lance in the furnace based on the comparison of the actual condition data to the target parameters at step 106. The method may include additional steps in certain examples. As discussed below, the three main steps may be described as including sub-steps.

Detecting Actual Conditions

As can be seen in FIG. 2, continuously detecting actual conditions at step 102 includes multiple sub-steps. The sub-steps of step 102 will be described in more detail in this section. The reader should understand that none of the sub-steps described below are required and that other examples of the methods described herein will include fewer or additional steps than present in the current method 100 example or all the sub-steps 102 and 104 taken simultaneously.

In the present example, step 102 incudes continuously detecting actual conditions in a set interval of 1 to 60 seconds at step 108. In other examples, the interval is a shorter or longer timeframe, such as every 0.1 seconds, every 5 minutes, or every 10 minutes. The interval timeframe may vary to be different timeframes throughout the BOF process or at defined stages of the BOF process. The interval timeframe is selected to be relatively small compared to the rate of change of actual conditions in the BOF process such that actual conditions are detected frequently. Frequently detecting actual conditions allows method 100 to fine tune the position of the lance to improve the BOF process.

As shown in FIG. 2, continuously detecting actual conditions at step 102 includes detecting the frequency at which the lance is vibrating 112. Any currently known or later developed device or technique for measuring lance vibration may be used to detect the lance vibration frequency at step 112. Some method examples do not include detecting lance vibration frequency.

The reader can see in FIG. 2 that continuously detecting actual conditions at step 102 includes detecting the frequency at which the furnace is vibrating at step 114. All conventional and future means to detect furnace vibration frequency may be utilized to detect furnace vibration frequency at step 114. In certain examples of the methods described herein, the furnace vibration frequency is not detected.

With further reference to FIG. 2, the reader can see that continuously detecting actual conditions at step 102 includes detecting the resistivity of the bath when the lance is electrically insulated at step 116 and when the lance is not electrically insulated at step 118. Any currently known or later developed device or technique for measuring the resistivity of the bath may be used to detect bath resistivity. In this example, the lance is used as an electrode to measure resistivity, but any techniques or electrodes may be used to measure resistivity. In general, resistivity is measured by supplying current and determining the voltage. The resistivity of the bath may not be required in all examples of the methods discussed here.

FIG. 2 further demonstrates that continuously detecting actual conditions at step 102 includes detecting the temperature of cooling water entering the lance at step 120 and leaving the lance at step 122. Any currently known or later developed device or technique for measuring water temperature may be used to detect the water temperature entering and leaving the lance at steps 120 and 122, respectively. Some method examples do not include detecting water temperature entering and/or leaving the lance.

As can be seen in FIG. 2, in the present example continuously detecting actual conditions at step 102 includes detecting the flow rate of oxygen from the lance at step 124 and the pressure of oxygen at step 126. All conventional and future devices or techniques for measuring oxygen flow rates and pressure may be used to detect the oxygen flow rate and pressure at steps 124 and 126, respectively. The reader will appreciate that certain examples of the methods descried herein do not include detecting oxygen flow rate and/or pressure.

With further reference to FIG. 2, continuously detecting actual conditions at step 102 includes detecting the position of the lance at step 128. The position of the lance may be expressed in terms relative to the furnace of relative to the level of a bath within the furnace. Any currently known or later developed device or technique for measuring the position of the lance may be used to detect the lance's position at step 128. Detecting the lance position may not be required in all examples of the methods described herein.

FIG. 2 further demonstrates that continuously detecting actual conditions at step 102 includes detecting the temperature of exhaust gas from the furnace at step 130. All conventional and future means to detect gas temperature may be utilized to detect exhaust gas temperature at step 130. In certain examples of the methods described herein, the furnace exhaust gas temperature is not detected.

Comparing Actual Conditions to Target Parameters

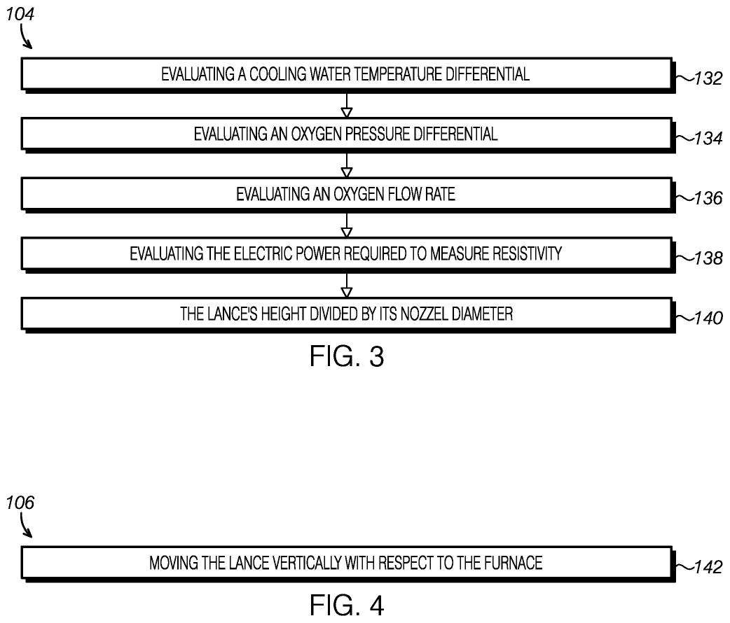

Turning attention to FIG. 3, sub-steps of comparing actual conditions to target parameters at step 104 will now be described. The sub-steps below are optional steps and not all methods will include each of them, Certain examples do not include any of the sub-steps described below.

In some examples, the comparisons described below are performed by a person without the aid of computers or other processors, while in other examples, computers and processors execute programed instructions to carry out the comparison steps described below.

As shown in FIG. 3, continuously comparing actual conditions to target parameters at step 104 includes evaluating the difference between the temperature of cooling water leaving the lance and the temperature of cooling water entering the lance at step 132. In the present example, step 104 further includes evaluating the difference between a theoretical oxygen pressure and a detected actual oxygen pressure at step 134. Different from detecting the flow rate of oxygen at step 124, continuously comparing actual conditions to target parameters at step 104 includes evaluating or calculating the flow rate of oxygen 136 using selected equations and system attributes.

With continued reference to FIG. 3, the reader can see that continuously comparing actual conditions to target parameters at step 104 includes evaluating the electric power required to measure resistivity of the bath at step 138. Step 104 further includes evaluating the height of the lance divided by the diameter of a nozzle opening of the lance at step 140. Other method examples may include additional, alternative, or fewer evaluation sub-steps than described here for step 104.

Adjusting the Position of the Lance

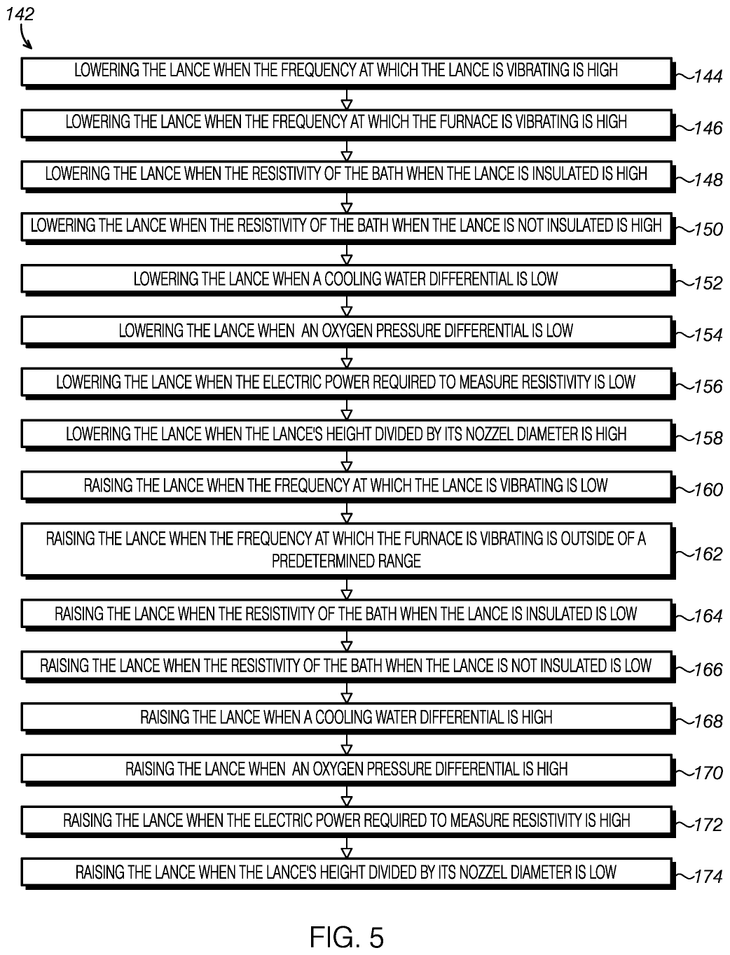

With reference to FIGS. 4 and 5, sub-steps of adjusting the position of the lance at step 106 will now be described. The reader should understand that none of the sub-steps described below are required and that other examples of the methods described herein will include fewer or additional steps than present in the current method 100 example.

The degree to which the lance position is adjusted may be predetermined set amounts and/or predetermined amounts based on the comparison of actual conditions to target parameters. For example, if the comparison indicates that the actual conditions deviate from the target parameters by a first amount, the method may include adjusting the lance position by a first distance. If the comparison indicates that the actual conditions deviate from the target parameters by a second amount larger than the first amount, the method may include adjusting the lance position by a second distance that is greater than the first distance. In other examples, the method adjusts the position of the lance by a set amount each time the comparison indicates that the actual conditions deviate from target parameters rather than amount proportional to the magnitude of the deviation.

In some examples, adjusting the position of the lance is performed by a person without the aid of computers or other processor. In other examples, computers and processors execute programed instructions to adjust the position of the lance, including when and where to adjust the position of the lance, according to the method steps described below.

As shown in FIG. 4, continuously adjusting the position of the lance at step 106 includes moving the lance vertically within the furnace at step 142. Additionally or alternatively, the methods discussed here may include moving the lance horizontally forwards or backwards or left or right. In some examples, moving the lance includes rotating or tilting the lance.

With reference to FIG. 5, moving the lance vertically with respect to the furnace at step 142 includes lowering the lance at step 144 when comparing the actual conditions to the target parameters indicates the frequency at which the lance is vibrating is higher than an associated target parameter. At step 146, the method includes lowering the lance when the frequency at which the furnace is vibrating is higher than an associated target parameter. Step 142 further involves lowering the lance when the resistivity of the bath at a portion of the lance where the lance is insulated is greater than an associated target parameter at step 148. At step 150, method 100 further includes lowering the lance when the resistivity of the bath at a portion of the lance where the lance is not insulated is greater than an associated target parameter.

With continued reference to FIG. 5, step 142 includes lowering the lance at step 152 when the difference between the temperature of cooling water leaving the lance and the temperature of cooling water entering the lance is lower than an associated target parameter. At step 154, the lance is lowered when the difference between a theoretical oxygen pressure and a detected actual oxygen pressure is lower than an associated target parameter. Step 142 further includes lowering the lance at step 156 when the electric power required to measure resistivity of the lance is lower than an associated target parameter. In the present example at step 158, the lance is lowered when the height of the lance divided by the diameter of a nozzle opening of the lance is within an upper portion of an associated target parameter range.

With continued focus on FIG. 5, the reader can see that moving the lance vertically with respect to the furnace at step 142 includes raising the lance at step 160 when comparing the actual conditions to the target parameters indicates the frequency at which the lance is vibrating is lower than an associated target parameter. At step 162, method 100 includes raising the lance when the frequency at which the furnace is vibrating is lower than an associated target parameter. Step 142 further involves raising the lance when the resistivity of the bath at a portion of the lance where the lance is insulated is lower than an associated target parameter at step 164. At step 166, step 142 further includes raising the lance when the resistivity of the bath at a portion of the lance where the lance is not insulated is lower than an associated target parameter.

With continued reference to FIG. 5, step 142 includes raising the lance at step 168 when the difference between the temperature of cooling water leaving the lance and the temperature of cooling water entering the lance is high than an associated target parameter. At step 170, the lance is raised when the difference between a theoretical oxygen pressure and a detected actual oxygen pressure is higher than an associated target parameter, Step 142 further includes raising the lance at step 172 when the electric power required to measure resistivity of the lance is higher than an associated target parameter. In the present example at step 174, the lance is raised when the height of the lance divided by the diameter of a nozzle opening of the lance is lower than an associated target parameter.

For reference purposes of one example only, suitable target parameter ranges for different defined ranges are provided in the table below. The table defines parameter ranges for five defined reaction states A, B, C, D, and E for various different parameters. In the example target parameter ranges below, methods of controlling the position of a lance as described herein may move the lance downwards when the actual conditions simultaneously fall in target parameter ranges in reaction states B or C until the actual conditions substantially conform to the parameter ranges in reaction state A, Similarly, the method may include moving the lance upwards when the actual conditions simultaneously fall in target parameter ranges in reaction states D or E until the actual conditions substantially conform to parameter ranges A. The reader should understand that the target parameters may vary in other examples and the number of reaction states defined may be larger or smaller.

TABLE 1
Example Target Parameter Ranges Defining 5 Reaction States.

| | | | | | | |
|---|---|---|---|---|---|---|
| Parameter | Units | Range A | Range B | Range C | Range D | Range E |

Parameters already collected at plant

| | | | | | | | |
|---|---|---|---|---|---|---|---|
| 1 | Temperature of incoming cooling | ° C. | 10-30 | 10-30 | 10-30 | 10-30 | 10-30 |
| | water to the lance [symbol] | | | | | | |
| 2 | Temperature of outgoing cooling | ° C. | 25-50 | 10-30 | 24-40 | 30-60 | 35-70 |
| | water from the lance [symbol] | | | | | | |
| 3 | Oxygen flow rate | [symbol] | 100-1000 | 100-1000 | 100-1000 | 100-1000 | 100-1000 |
| 4 | Oxygen pressure | MPa | 0-2 | 0-2 | 0-2 | 0-2 | 0-2 |
| 5 | Lance location [symbol] | [symbol] | 0.5-10 | 0.5-10 | 0.5-10 | 0.5-10 | 0.5-10 |
| 6 | Temperature of the [symbol] gas | ° C. | 850-1100 | 500-600 | 600-700 | 700-800 | 800-850 |
| | [symbol] a [symbol] before the gas | | | | | | |
| | separation [symbol] | | | | | | |

Parameters specially measured for the invention

| | | | | | | | |
|---|---|---|---|---|---|---|---|
| 7 | Frequency of the lance vibration | [symbol] | [symbol] -300 | 300-500 | 300-400 | 100-150 | 50-100 |
| 8 | Frequency of the [symbol] vibration | [symbol] | 5-110 | 20-30 | 15-20 | 10-15 | 1-5 |
| 9 | [symbol] at lance [symbol] insulation | [symbol] | 0.5-0.01 | [symbol] | [symbol] | [symbol] | [symbol] |
| 10 | [symbol] at lance without insulation | [symbol] | [symbol] | [symbol] | [symbol] | [symbol] | [symbol] |

Parameters calculated for the invention

| | | | | | | | |
|---|---|---|---|---|---|---|---|
| 1 | Temperature difference [symbol] | [symbol] | [symbol] | [symbol] | [symbol] | [symbol] | [symbol] |
| 2 | Difference in oxygen pressures [symbol] | [symbol] | [symbol] | [symbol] | [symbol] | [symbol] | [symbol] |
| 3 | Oxygen flow rate | [symbol] | 1-5 | 1-5 | 1-5 | 1-5 | 1-5 |
| 4 | Electric power requires to measure [symbol] | [symbol] | [symbol] | [symbol] | [symbol] | [symbol] | [symbol] |
| 5 | Lance height [symbol] | [symbol] | 30-100 | 50-100 | 40-100 | 20-100 | 0-100 |

[symbol]

[symbol]

[symbol]

indicates data missing or illegible when filed

### INDUSTRIAL APPLICABILITY

The inventions described in this application describe industrial steel making processes and thus have industrial applicability.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A method for controlling the position of a lance supplying oxygen to a furnace containing a bath of molten metal, comprising the steps of:
evaluating a resistivity of the bath when the lance is electrically insulated with a first measuring device that detects resistance of the bath;
continuously comparing the resistivity of the bath to a first resistivity target parameter corresponding to the resistance of the bath; and
continuously adjusting the position of the lance with respect to the furnace based on the comparison of the resistivity of the bath to the first resistivity target parameter.

2. The method of claim 1, further comprising the steps of:
evaluating a resistivity of the bath when the lance is not electrically insulated with a second measuring device that detects resistance of the bath;
continuously comparing the resistivity of the bath to a second resistivity target parameter corresponding to the resistance of the bath; and
continuously adjusting the position of the lance with respect to the furnace based on the comparison of the resistivity of the bath to the second resistivity target parameter.

3. The method of claim 1, further comprising the steps of:
evaluating a furnace vibration frequency with a third measuring device that detects frequency of vibrations of the furnace;
continuously comparing the furnace vibration frequency to a furnace vibration target parameter corresponding to the frequency of vibrations of the furnace; and
continuously adjusting the position of the lance with respect to the furnace based on the comparison of the furnace vibration frequency to the furnace vibration target parameter.

4. The method of claim 1, further comprising:
evaluating a second resistivity of the bath when the lance is not electrically insulated with a second measuring device that detects resistance of the bath;
evaluating a furnace vibration frequency with a third measuring device that detects frequency of vibrations of the furnace;
evaluating a lance vibration frequency with a fourth measuring device that detects frequency of vibrations of the lance;
continuously comparing the furnace vibration frequency, the first resistivity of the bath, and the second resistivity of the bath to the lance vibration target parameter, the furnace vibration target parameter, the first resistivity target parameter, and the second resistivity target parameter, respectively;
continuously adjusting the position of the lance with respect to the furnace based on the comparison of the furnace vibration frequency, the first resistivity of the bath, and the second resistivity of the bath of the bath to the lance vibration target parameter, the furnace vibration target parameter, the first resistivity target parameter, and the second resistivity target parameter, respectively.

5. The method of claim 4, wherein continuously adjusting a vertical position of the lance comprises:
lowering the vertical position of the lance when the lance vibration frequency is higher than the lance vibration frequency target parameter;
lowering the vertical position of the lance when the furnace vibration frequency is higher than the furnace vibration frequency target parameter;
lowering the vertical position of the lance when the first resistivity of the bath is higher than the first resistivity target parameter; and
lowering the vertical position of the lance when the second resistivity of the bath is higher than the second resistivity target parameter.

6. The method of claim 5, wherein continuously adjusting a vertical position of the lance comprises:
raising the lance when the first resistivity of the bath is less than the first resistivity target parameter; and
raising the lance when the second resistivity of the bath is less than the second resistivity target parameter.

7. The method of claim 1, further comprising:
continuously detecting actual conditions associated with the furnace, wherein continuously detecting actual conditions further comprises:
detecting the temperature of cooling water entering the lance;
detecting the temperature of cooling water leaving the lance;
detecting the flow rate of oxygen;
detecting the pressure of oxygen;
detecting the position of the lance; and
detecting the temperature of exhaust gas from the furnace;
continuously comparing the actual conditions to target parameters corresponding to the actual conditions; and
continuously adjusting the position of the lance with respect to the furnace based on the comparison of the actual conditions to the target parameters.

8. The method of claim 6, continuously comparing the actual conditions to target parameters comprises:
evaluating a difference between the temperature of cooling water leaving the lance and the temperature of cooling water entering the lance;
evaluating a difference between a theoretical oxygen pressure and a detected actual oxygen pressure;
evaluating a flow rate of oxygen;
evaluating an electric power required to measure resistivity of the bath; and
evaluating a height of the lance divided by the diameter of a nozzle opening of the lance.

9. The method of claim 7, wherein continuously adjusting a vertical position of the lance comprises:
lowering the lance in response to a difference between the temperature of cooling water leaving the lance and the temperature of cooling water entering the lance is lower than a water temperature target parameter associated with the difference between the temperature of cooling water leaving the lance and the temperature of cooling water entering the lance;
lowering the lance in response to a difference between a theoretical oxygen pressure and a detected actual oxygen pressure is lower than an oxygen pressure target parameter associated with the difference between the theoretical oxygen pressure and the detected actual oxygen pressure;
lowering the lance in response to an electric power required to measure resistivity of the bath is lower than an electric power target parameter associated with the electric power required to measure resistivity of the bath; and
lowering the lance in response to a height of the lance divided by the diameter of a nozzle opening of the lance is within an upper portion of a geometry target parameter range associated with the height of the lance divided by the diameter of the nozzle opening of the lance.

10. The method of claim 7, wherein continuously adjusting a vertical position of the lance comprises:
raising the lance when a difference between the temperature of cooling water leaving the lance and the temperature of cooling water entering the lance is greater than a water temperature target parameter associated with the difference between the temperature of cooling water leaving the lance and the temperature of cooling water entering the lance;
raising the lance when a difference between the theoretical oxygen pressure and the detected actual oxygen pressure is greater than an oxygen pressure target parameter associated with the difference between the theoretical oxygen pressure and the detected actual oxygen pressure;
raising the lance when the electric power required to measure resistivity of the lance is greater than an electric power target parameter associated with the electric power required to measure resistivity of the lance; and
raising the lance when the height of the lance divided by a diameter of the nozzle opening of the lance is less than a geometry target parameter range associated with the height of the lance divided by the diameter of the nozzle opening of the lance.

11. A method for controlling the position of a lance supplying oxygen to a furnace containing a bath of molten metal, comprising the steps of:
evaluating a lance vibration frequency with a fourth measuring device that detects frequency of vibrations of the lance;
continuously comparing the lance vibration frequency to a lance vibration target parameter corresponding to the frequency of vibrations of the lance; and
continuously adjusting the position of the lance with respect to the furnace based on the comparison of the lance vibration frequency to the lance vibration target parameter.

12. The method of claim 11, wherein:
the method further comprises the steps of:
evaluating a furnace vibration frequency with a third measuring device that detects frequency of vibrations of the furnace;
continuously comparing the furnace vibration frequency to a furnace vibration target parameter corresponding to the frequency of vibrations of the furnace; and
continuously adjusting the position of the lance with respect to the furnace based on the comparison of the furnace vibration frequency to the furnace vibration target parameter; and
continuously adjusting a vertical position of the lance comprises:
raising the vertical position of the lance when the lance vibration frequency is lower than the lance vibration target parameter; and
raising the vertical position of the lance when the furnace vibration frequency is outside a furnace vibration target parameter range associated with the frequency at which the furnace is vibrating.

13. A method for controlling the position of a lance supplying oxygen to a furnace containing a bath of molten metal, comprising the steps of:
continuously detecting actual conditions associated with the furnace, wherein continuously detecting actual conditions includes detecting a height of the lance;
continuously comparing the actual conditions to target parameters corresponding to the actual conditions, wherein continuously comparing the actual conditions to target parameters includes comparing the height of the lance divided by a diameter of a nozzle opening of the lance; and
continuously adjusting the position of the lance with respect to the furnace based on the comparison of the actual conditions to the target parameters.

14. The method of claim 13, wherein:
continuously detecting actual conditions includes detecting a pressure of oxygen in the furnace; and
continuously comparing the actual conditions to target parameters includes comparing a difference between a theoretical oxygen pressure and a detected actual oxygen pressure.

15. The method of claim 13, wherein:
continuously detecting actual conditions includes detecting a flow rate of oxygen in the furnace; and
continuously comparing the actual conditions to target parameters includes comparing a difference between a flow rate of oxygen parameter and the detected actual flow rate of oxygen.
